(19) United States
(12) Patent Application Publication
(10) Pub. No.: US 2019/0106974 A1
(43) Pub. Date: Apr. 11, 2019

(54) SYSTEMS AND METHODS FOR HORIZONTAL WELL GEOSTEERING

(71) Applicant: ROGII INC., HOUSTON, TX (US)

(72) Inventors: IGOR KUVAEV, Houston, TX (US); IGOR UVAROV, Houston, TX (US)

(73) Assignee: ROGII INC., HOUSTON, TX (US)

(21) Appl. No.: 15/727,434

(22) Filed: Oct. 6, 2017

(51) Int. Cl. E21B 44/00; G05B 19/402; E21B 49/00; E21B 7/04

(52) U.S. Cl. CPC E21B 44/00; G05B 19/402; G05B 2219/36292; E21B 7/046; E21B 49/00

(57) ABSTRACT

Systems and methods for drilling a horizontal well. The method compromises estimating the well's position in the target formation using data acquired during the drilling process, data from the nearby wells as well as other relevant data, including, without limitation, seismic, geomodels and structural maps. The method may additionally involve correcting a wellbore trajectory to ensure that the trajectory stays within the target formation.

### BACKGROUND OF THE INVENTION

### Technical Field

The disclosed embodiments relate in general to the field of horizontal well geosteering. More particularly, the disclosed embodiments relate to geosteering with variable formation thickness as well as data integration during the geosteering process.

### Description of the Related Art

Oil and gas bearing rocks are usually present in layered formations. In the past, mostly vertical wells were drilled in order to extract hydrocarbons from such rock formations. However, more recently, the oil and gas industry started to drill more and more horizontal wells that run along the productive formation and result in much better hydrocarbon extraction output.

In the context of drilling a well borehole, a term geosteering describes a process of adjusting the borehole position (inclination and azimuth angles) in real time to reach one or more geological targets. In according to the conventional technology, these geosteering adjustments are calculated based on geological information gathered before or during the drilling process. For this reason, the aforesaid geosteering is the critical process of drilling the horizontal well. It is particularly important because the geological formation is not always horizontal, but can have bends (various formation dips), faults and can vary in its thickness. The majority of the horizontal wells in the world are being geosteered to ensure maximum exposure to the hydrocarbon containing rock and, consequently, better oil and gas extraction performance.

As it is well known in the art, geosteering is usually conducted with the help of a specialized geosteering software, which is configured to process the aforesaid collected multitude of data and assist the geologists in understanding the wellbore's position within the oil or gas reservoir. The aforesaid geosteering software may further be used for adjusting wellbore's position. On the other hand, the conventional geosteering software commercially available on the market today is designed using a single-well and single-log constant formation thickness approach, which is subject to substantial limitations and, as a consequence, no longer meets the industry requirements.

Therefore, there is a strong industry need for more efficient geosteering software, which would assist drilling rig operators and field service companies in aggregating all available data and generating more accurate geosteering guidance while drilling horizontal wells.

### SUMMARY OF THE INVENTION

The embodiments described herein are directed to methods and systems that substantially obviate one or more of the above and other problems associated with conventional geosteering techniques.

In accordance with one aspect of the inventive concepts described herein, there is provided a computer-implemented method for horizontal well geosteering, the method being performed in a computerized system comprising at least a processing unit, a data input-output unit and a memory, the computer-implemented method comprising: performing loading of data using the data input-output unit; using at least the processing unit for adjusting a thickness of a rock formation; adjusting a formation dip model of the rock formation; projecting logs onto a TVT scale; performing a comparison of vertical type logs in the TVT scale; performing a comparison of the formation dip model with at least one of: seismic data, map information, nearby wells data or geomodels data; performing a comparison of the formation dip model with a desired target line; and performing an update of the target line.

In accordance with another aspect of the inventive concepts described herein, there is provided a computer-implemented method for horizontal well geosteering with variable formation thickness, the method being performed in a computerized system comprising at least a processing unit, a data input-output unit and a memory, the computer-implemented method comprising: modifying a formation thickness of a formation dip (structural model) on a cross-section; and using a model with variable formation thickness to project the logs onto a TVT scale.

In accordance with yet another aspect of the inventive concepts described herein, there is provided a computer-implemented method for horizontal well geosteering using a plurality of logs, the method being performed in a computerized system comprising at least a processing unit, a data input-output unit and a memory, the computer-implemented method comprising performing a comparison of the multiple projected logs in a TVT scale with multiple type wells.

In accordance with yet another aspect of the inventive concepts described herein, there is provided a computer-implemented method for horizontal well geosteering for a plurality of wells, the method being performed in a computerized system comprising at least a processing unit, a data input-output unit and a memory, the computer-implemented method comprising performing a comparison of the plurality of wells and an associated formation dip (structural) model on a same cross-section.

In accordance with yet another aspect of the inventive concepts described herein, there is provided a computer-implemented method for horizontal well geosteering, the method being performed in a computerized system comprising at least a processing unit, a data input-output unit and a memory, the computer-implemented method comprising: using the at least a processing unit to perform the geosteering of the horizontal well; and using a seismic, geomodel and structural model backdrop to constrain the horizontal well geosteering.

In accordance with yet another aspect of the inventive concepts described herein, there is provided a computer-implemented method, the method being performed in a computerized system comprising at least a processing unit, a data input-output unit and a memory, the computer-implemented method comprising: using the at least a processing unit to perform a geosteering of a horizontal well; and correcting structural maps and models based on results of the geosteering.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary flow diagram of an embodiment of an inventive method for performing the geosteering operation in a context of a horizontal or other directional well drilling.

FIG. 2 illustrates an exemplary embodiment of a process for multi-log geosteering with variable formation thickness.

FIG. 3 illustrates an exemplary comparison with seismic and geomodel data.

FIG. 4 illustrates an exemplary embodiment of a multi-well geosteering process.

FIG. 5 illustrates an exemplary correction of the structural maps and models based on the results of the geosteering.

FIG. 6 is a block diagram illustrating an exemplary embodiment of a computerized system for implementing various embodiments of the present invention described herein.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one aspect of the embodiments described herein, there are provided systems and methods for performing geosteering operation under conditions of variable oil or gas containing rock formation thickness. In accordance with another aspect of the described embodiments, aggregation of various data is performed during the geosteering process, wherein the aggregated data is subsequently used for calculating the geosteering adjustments. In one or more embodiments, the calculated geosteeting adjustments are both displayed to the operator of the drilling rig and automatically transmitted to the drill in real-time, wherein they are used for drill guidance.

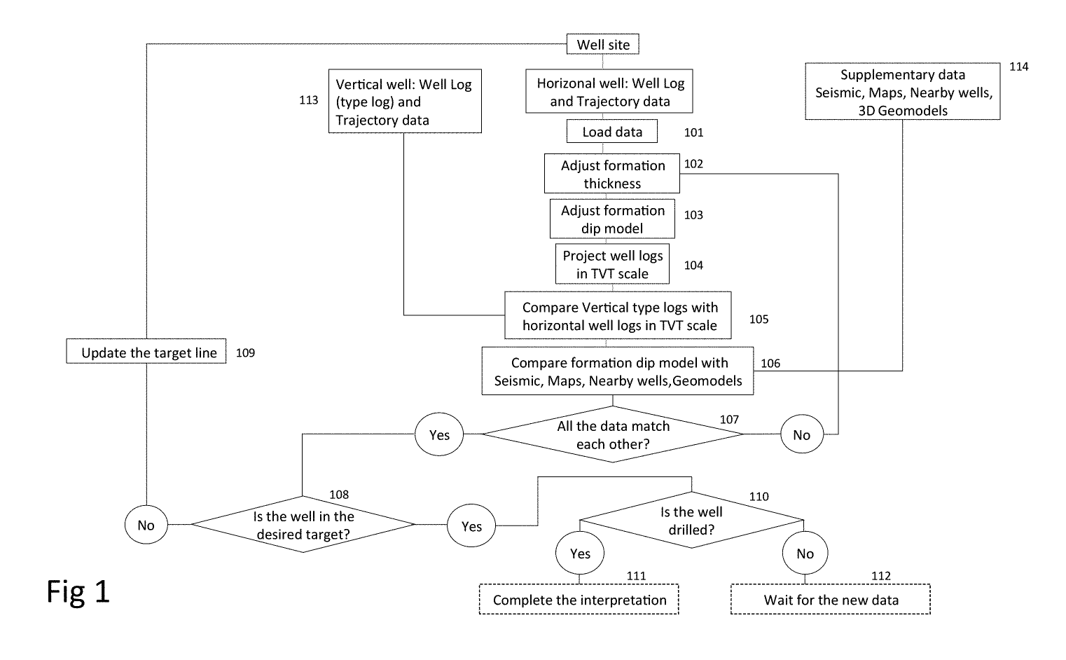

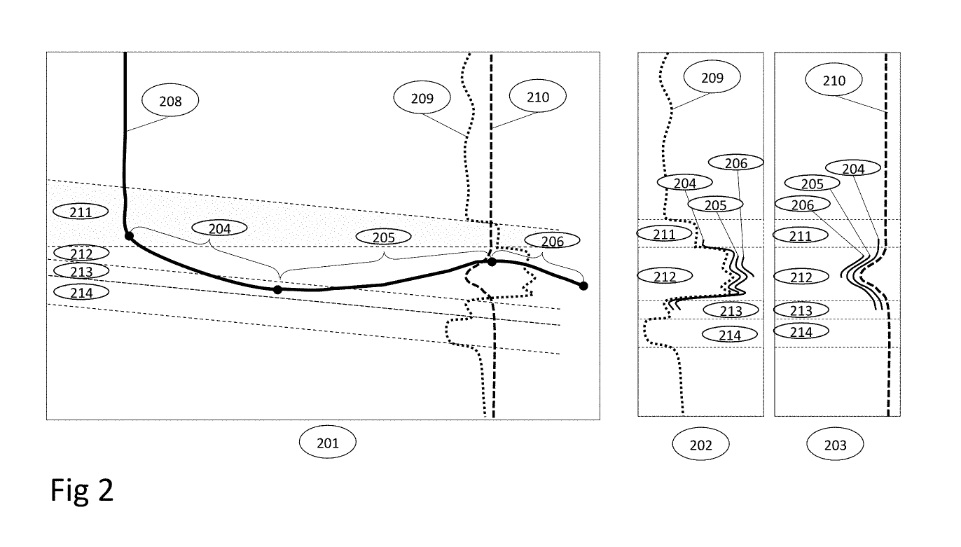

FIG. 1 illustrates an exemplary flow diagram of an embodiment of an inventive method for performing the geosteering operation in a context of a horizontal or other directional well drilling. At step 101, a horizontal well log and well trajectory data are loaded into the geosteering software. In various embodiments, the aforesaid trajectory data may be provided in xls, txt or other suitable data formats. On the other hand, the aforesaid horizontal well log data may be provided in las, txt or other appropriate formats. At step 102, the oil or gas containing rock formation thickness may be appropriately modified, for example, using a process illustrated in detail in FIG. 2. In various embodiments, the rock formation thickness may be reduced for certain rock formations along the wellbore. In an alternative embodiment, the rock formation thickness may be defined as a variable, which would change its value within a predetermined range along the lateral direction.

At step 103, the rock formation dip is adjusted according to a regional formation dip and based on the comparison with vertical type log, as shown in step 105. This process is illustrated in detail in FIG. 2. At step 104, logs from horizontal well are projected onto the TVT scale based on the formation thickness, and formation dip from steps 102 and 103. FIG. 2 illustrates this process in detail. At step 105, projected log in TVT scale is compared with type log. In various embodiments, single or multiple logs may be compared with the associated type log. If multiple logs are used, then the aforesaid process is called a multi-log geosteering.

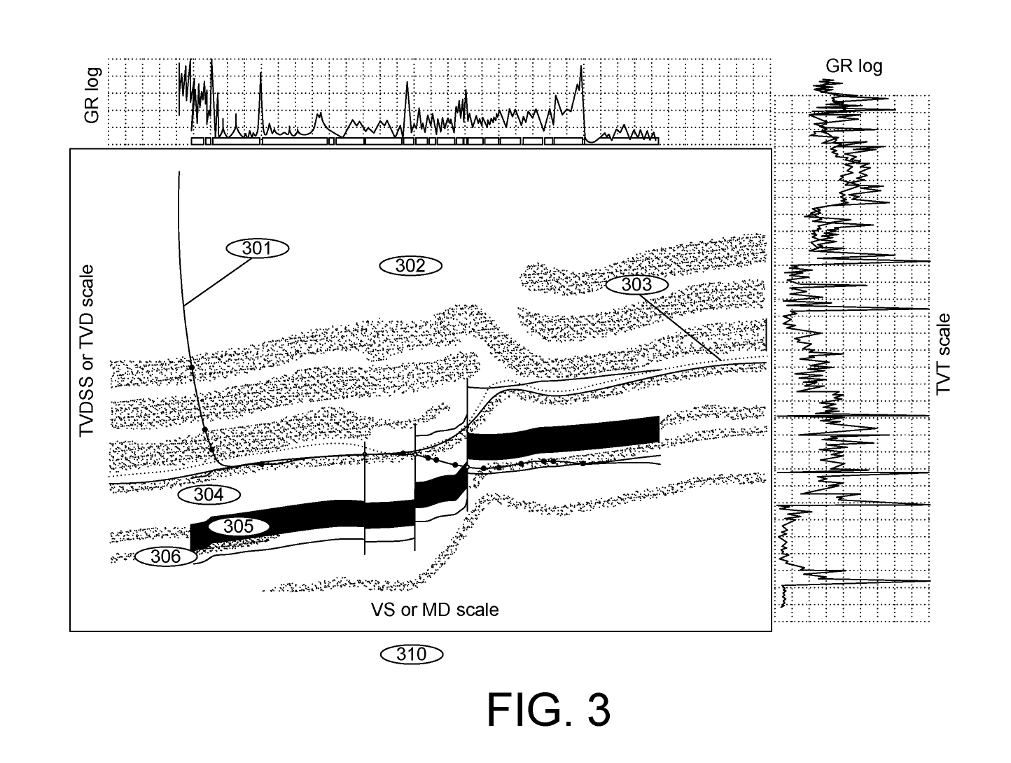

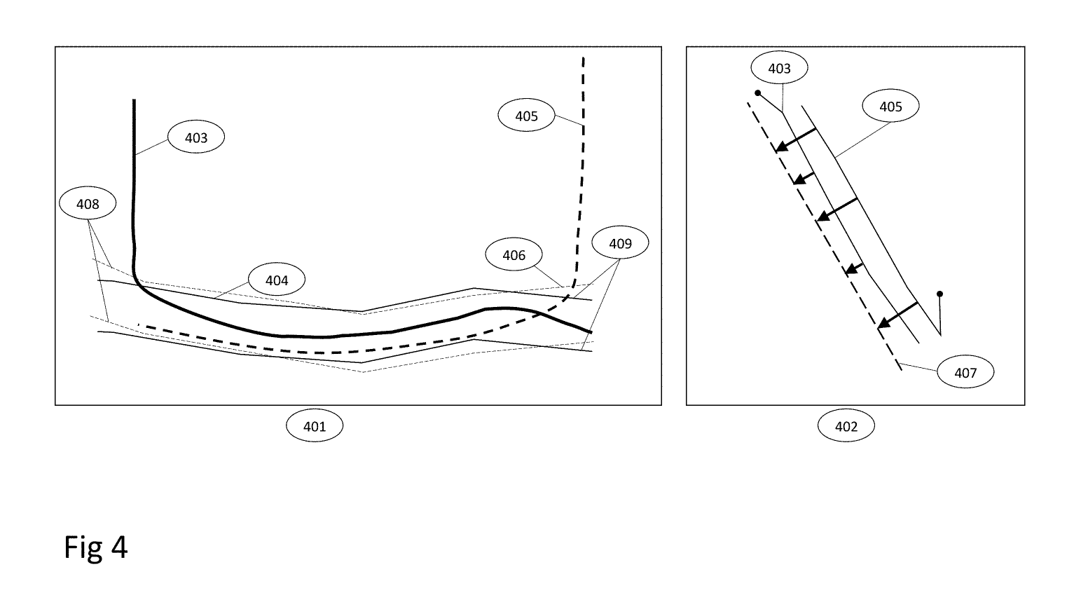

At step 106, resulting formation dip (structural) model is compared with seismic data, geomodels, 2D grids (maps), and/or nearby wells (so called multi-well geosteering process). FIG. 3 illustrates an exemplary comparison with seismic and geomodel data. FIG. 4 illustrates an exemplary embodiment of a multi-well geosteering process. If the comparison does not show a good match, then all the steps starting with step 102 are repeated. If the above data provides a good match and the well is in the desired target, then the interpretation is completed (if the well was drilled, step 111) or the geosteering software waits for the new data (if the well has not been drilled, the operation proceeds to step 112). If the well is not in the desired target, then the target line is updated to adjust the wellbore trajectory to get into the target formation.

FIG. 2 illustrates an exemplary embodiment of a process of projecting a horizontal well log into the TVT scale. In one embodiment, this process may use layer thickness information taken from the type well. In an alternative embodiment, the aforesaid process may use a modified formation thickness, as generated at step 102 of the process shown in FIG. 1. In addition, FIG. 2 illustrates multi-log geosteering approach. Image 201 illustrates a cross-section display that may be plotted in VS, MD, THL, or similar horizontal scale and TVD, TVDSS vertical scale. In addition, it shows horizontal well (208) and interpreted formations (211, 212, 213, 214). As can be seen from FIG. 2, the formation thickness of formations 211 and 212 is changing along the wellbore. Type well data is showed at the toe of the horizontal well in the image 201 and two logs from the type well are displayed on the cross-section: Log1 (209) and Log2 (210). In various embodiments, the aforesaid logs may be gamma ray logs, density logs or any other type of logs.

In the embodiment shown in FIG. 2, the horizontal well (208) is split into the following three sections (segments): 204, 205 and 206. Images 202 and 203 are illustrating the projection of log data from these segments into the TVT scale. In one embodiment, the purpose of projecting the logs into the TVT scale is to compare log signatures from the type well with the projected log signatures from the horizontal well on the same plot.

Below is an example that demonstrates how the data can be projected in the TVT scale from three different segments with variable formation thickness: segment 204 on image 201 starts at the bottom of the formation 211, penetrates the formation 212 and ends at the middle of the formation 213. The same behavior is observed on the TVT scale with respect to plots 202 and 203: the segment 204 starts at the bottom of the formation 211, penetrates the formation 212 and ends in the middle of the formation 213. Segment 205 in the image 201 starts in the middle of the formation 213 and ends in the formation 212. The same behavior can be observed on the images 202 and 203: the segment 205 starts in the middle of the formation 213 and ends in the formation 212. The last segment 206 in the image 201 starts close to the top of the formation 212 and goes downwards, ending in the middle of the formation 212. The same behavior can be observed in the images 202 and 203: the segment 206 starts close to the top of the formation 212 and goes downwards, ending in the middle of the formation 212.

FIG. 3 illustrates an exemplary embodiment of a process of comparison of the formation dip (structural model) with seismic, geomodel and/or maps (grid) data. In this figure, the image 310 illustrates a cross-section display that may be plotted in the VS, MD, THL, or similar horizontal scale and the TVD, TVDSS vertical scale. Horizontal well (301) and interpreted formations (304,305,306) are displayed on the cross-section.

In various embodiments, geosteering may be constrained using the seismic and geomodel data. In one embodiment, the seismic backdrop displayed on the cross-section (302). In various embodiments, it may be a slice from a 3D seismic volume or a 2D seismic line. In addition, a geological model may be displayed on the cross-section as well. In various embodiments, geosteering may also be constrained to the grid or structural map data. It should be noted that element 303 in FIG. 3 represents a slice through the 2D grid displayed on the cross-section.

FIG. 4 illustrates an exemplary embodiment of a multi-well geosteering process. In that figure, image 402 illustrates a map view, with two wells drilled (wells 403 and 405). Dashed line 407 represents a VS plane. Image 401 illustrates a cross-section display that can be plotted in VS, MD, THL, or similar horizontal scale as well as TVD or TVDSS vertical scale. In this figure, two horizontal wells are displayed on the cross-section, which are the wells 403 and 405. In order to display these wells in the same cross-section, both of these wells are projected onto the same VS plane, which is shown in image 402 as a dashed line. Geosteered formations, which are formations interpreted as a result of the geosteering, from the well 403 are marked as element 408. Geosteered formations from the well 405 are marked as 409. Both of these formations are also projected onto the same VS plane, which is displayed in the image 402 as a dashed line.

In various embodiments, the aforesaid multi-well geosteering process allows to compare formations or horizons geosteered in well 403 with formations or horizons geosteered in well 405. As would be appreciated by persons of ordinary skill in the art, this allows constraining the results of the geosteering in one well with the other well(s).

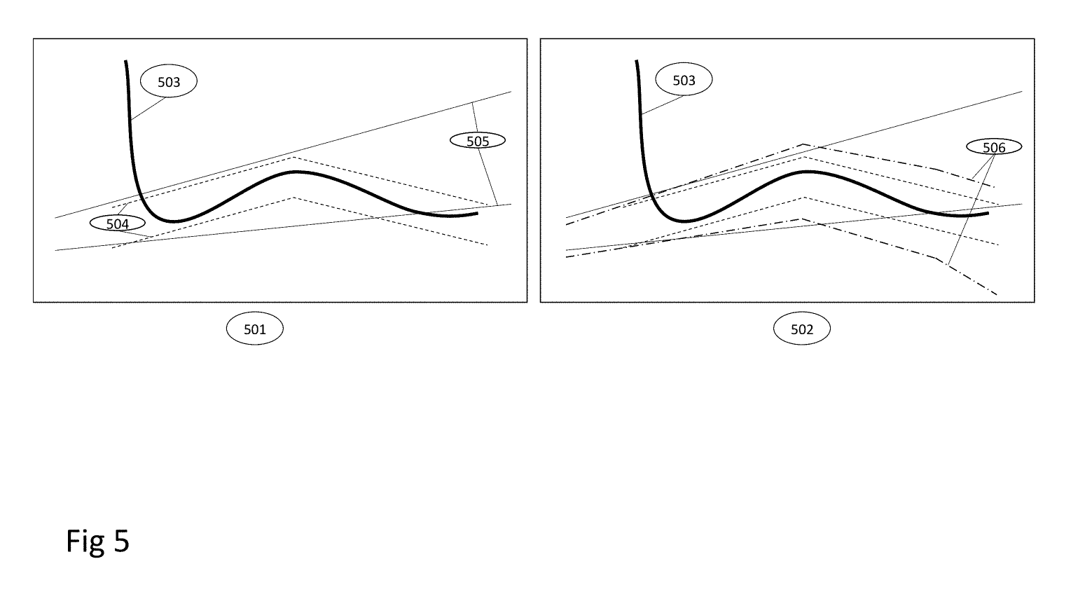

FIG. 5 illustrates an exemplary correction of the structural maps and models based on the results of the geosteering. In that figure, the images 501 and 501 show cross-section display that may be plotted in the VS, MD, THL or similar horizontal scale and the TVD or TVDSS vertical scale. The image 501 shows the horizontal well 503 and the geometry of the formation 504, which resulted from the geosteering process. Element 505 in FIG. 5 illustrates the formation model before the well was drilled.

The image 502 in FIG. 5 illustrates how the results of the geosteering 504 may be adjusted to fit the pre-drill formation thickness model 505. In the shown example, the resulting formation model 506 follows the geosteering model 504, but inherits the thickness from the formation thickness data 505.

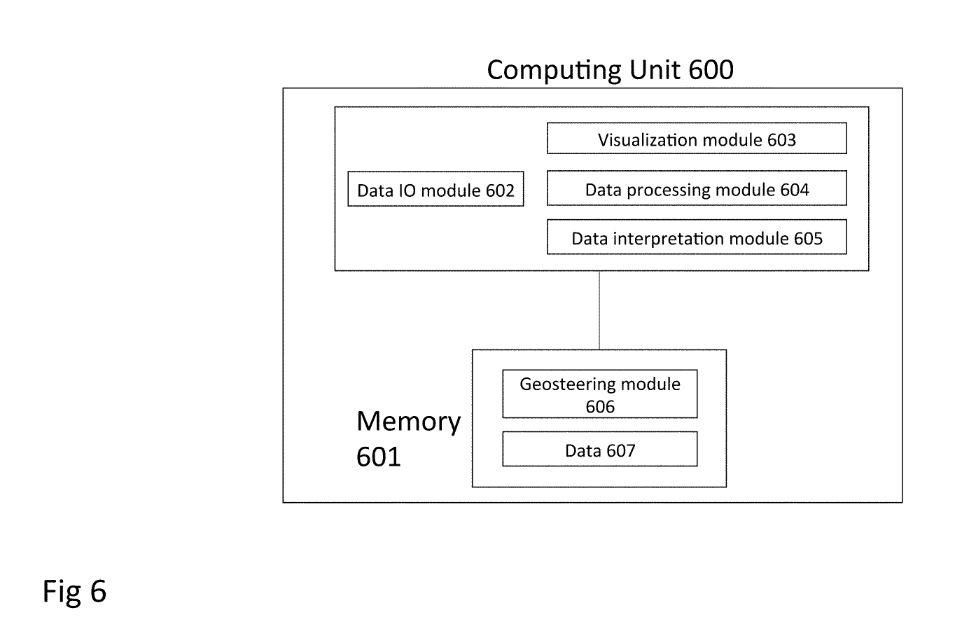

FIG. 6 is a block diagram illustrating an exemplary embodiment of a computerized system for implementing various embodiments of the present invention described herein. The exemplary embodiment of the computerized system shown in FIG. 6 incorporates a computing unit 600 that comprises a computer-readable memory 601, a data input/output module 602, a visualization module 603, a data processing module 604, as well as a data interpretation module 605. In the shown embodiment of the computerized system, the computer-readable memory 601 stores a geosteering module 606 as well as related data 607. In various embodiments, the aforesaid modules shown in FIG. 6 are executed by one or more processors, which could be either central processing units (CPUs) or graphics processing units (GPUs) (not shown in FIG. 6). Also not shown in FIG. 6 is a geosteering data transmission equipment configured to transmit the calculated geosteering data to the drill as well as the drill guidance system configured to guide the drill based on the received geosteering data.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in systems and methods for geosteering. It is intended that the specification and examples be considered as exemplary only, with a true scope and spirit of the invention being indicated by the following claims.

What is claimed is:

1. A computer-implemented method for horizontal well geosteering, the method being performed in a computerized system comprising at least a processing unit, a data input-output unit and a memory, the computer-implemented method comprising:
a. performing loading of data using the data input-output unit;
b. using at least the processing unit for adjusting a thickness of a rock formation;
c. adjusting a formation dip model of the rock formation;
d. projecting logs onto a TVT scale;
e. performing a comparison of vertical type logs in the TVT scale;
f. performing a comparison of the formation dip model with at least one of: seismic data, map information, nearby wells data or geomodels data;
g. performing a comparison of the formation dip model with a desired target line; and
h. performing an update of the target line.

2. A computer-implemented method for horizontal well geosteering with variable formation thickness, the method being performed in a computerized system comprising at least a processing unit, a data input-output unit and a memory, the computer-implemented method comprising:
a. modifying a formation thickness of a formation dip (structural model) on a cross-section; and
b. using model with variable formation thickness to project the logs onto a TVT scale.

3. A computer-implemented method for horizontal well geosteering using a plurality of logs, the method being performed in a computerized system comprising at least a processing unit, a data input-output unit and a memory, the computer-implemented method comprising performing a comparison of the multiple projected logs in a TVT scale with multiple type wells.

4. A computer-implemented method for horizontal well geosteering for a plurality of wells, the method being performed in a computerized system comprising at least a processing unit, a data input-output unit and a memory, the computer-implemented method comprising performing a comparison of the plurality of wells and an associated formation dip (structural) model on a same cross-section.

5. A computer-implemented method for horizontal well geosteering, the method being performed in a computerized system comprising at least a processing unit, a data input-output unit and a memory, the computer-implemented method comprising:
a. using the at least a processing unit to perform the geosteering of the horizontal well; and
b. using a seismic, geomodel and structural model backdrop to constrain the horizontal well geosteering.

6. A computer-implemented method, the method being performed in a computerized system comprising at least a processing unit, a data input-output unit and a memory, the computer-implemented method comprising:
a. using the at least a processing unit to perform a geosteering of a horizontal well; and
b. correcting structural maps and models based on results of the geosteering.
